(19) United States
(12) Patent Application Publication
(10) Pub. No.: US 2007/0281057 A1
(43) Pub. Date: Dec. 6, 2007

(54) Container for Pizzas

(76) Inventors: Pere Teixidor Casanovas, Ibiricu De Egues (ES); Fernando Manuel Canales Canas, Ibiricu De Egues (ES)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/750,380

(22) Filed: May 18, 2007

(30) Foreign Application Priority Data
May 18, 2006 (ES) 200601276

(51) Int. Cl. A23B 7/148

(52) U.S. Cl. 426/106

(57) ABSTRACT

The container for pizzas comprises a base (1) housing a pizza, and it is characterized in that said base (1) comprises a plurality of protrusions (2).

The separation between the protrusions (2) at the center of the base (1) is lower than the separation between the protrusions (2) at the edge of the base (1). The container can also comprise a lid (3) engageable to said base (1), said lid (3) comprising at least one hole (4) provided with a tongue (5). These protrusions prevent the whole lower surface of the pizza to be in contact with the base, so that it is provided a suitable ventilation of the lower surface of the pizza, preventing it get excessively wet.

The present invention refers to a container for pizzas, permitting a suitable ventilation of the lower surface of the pizza.

### BACKGROUND OF THE INVENTION

Cardboard containers which are usually used for the transportation of pizzas are well known. Usually, these containers are formed by a base and an articulated lid.

The problem of these conventional containers for pizzas is that they occupy a considerable space, because when the lid is opened it remains joined to the base.

To solve this drawback the container for pizzas disclosed in WO 2005/007525 A1 was devised, in the name of the same applicant than the present application.

In this document it is disclosed a container for pizzas formed by a base and a lid engageable to each other, the base and the lid being dish-shaped. With this container it is possible to separate completely the lid from the base, and it is possible to use the lid and the base as dishes. In this container the base is completely smooth.

Even though this container solves perfectly the drawback stated above, it was observed in the practice that the pizza can get excessively wet because it lower surface cannot be ventilated, because the base is smooth, as in the conventional containers for pizzas.

A solution to this problem is disclosed in the Spanish Utility model U200501046. This document discloses a tray for pizzas provided with a plurality of radial windows permitting the ventilation of the lower surface of the pizza.

This tray presents the drawback that its central part is not ventilated, because said radial windows do not reach the center of the tray. Furthermore, said windows could facilitate the entrance of dirt through them.

### DESCRIPTION OF THE INVENTION

With the container for pizzas of the invention said drawbacks can be solved, presenting other advantages that will be disclosed.

The container for pizzas of the present invention is formed by a base housing a pizza, and it is characterized in that said base comprises a plurality of protrusions.

These protrusions prevent the whole lower surface of the pizza to be in contact with the base, so that it is provided a suitable ventilation of the lower surface of the pizza, preventing it get excessively wet.

Advantageously, the separation between the protrusions at the center of the base is lower than the separation between the protrusions near the perimeter of the base. This arrangement of the protrusions is because the central part of the pizza is tenderer than the rest.

According to a preferred embodiment, the container of the present invention also comprises a lid engageable to said base, said lid comprising at least one hole provided with a tongue, which facilitated the removal of the lid, pulling upwardly the tongue.

### BRIEF DESCRIPTION OF THE DRAWINGS

For a better understanding of what have been described, some drawings are attached in which, diagrammatically and only as a non-limitative example, a practical case of embodiment is shown.

FIG. 1 us a perspective view of a first embodiment of the container of the present invention, provided with a lid separated from the base which forms the container;

FIG. 2 is a perspective view of a first embodiment of the container of the present invention, provided with a lid engaged to the base which forms the container;

FIG. 3 is a section view of the container of the present invention, with the lid engaged to the base which forms the container; and

FIG. 4 is a perspective view of a first embodiment of the container of the present invention, provided with a lid separated from the base which forms the container.

### DESCRIPTION OF A PREFERRED EMBODIMENT

As it can be seen in the drawings, the container of the present invention is formed by a base of cardboard provided with a plurality of protrusions 2.

The container can also comprise a lid 3 engageable to said base 1. It must be pointed out that said lid 3 is not indispensable, because the container of the present invention could be formed only by the base 1.

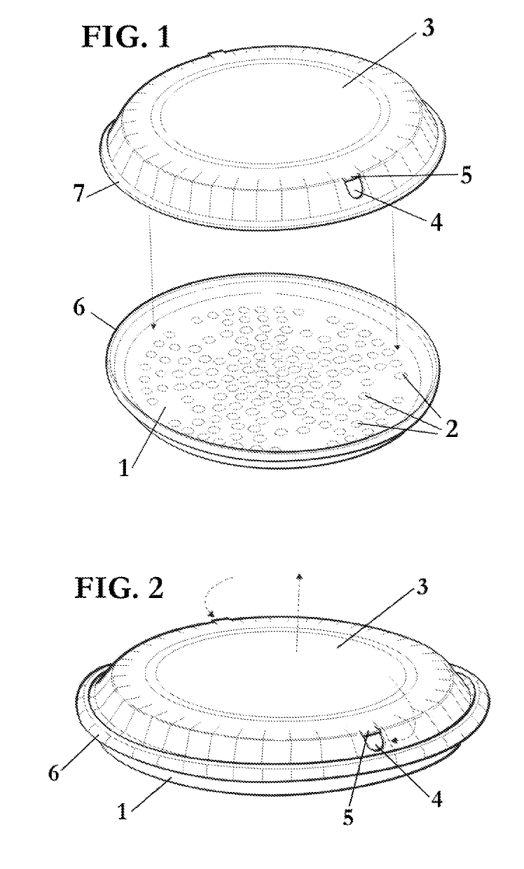

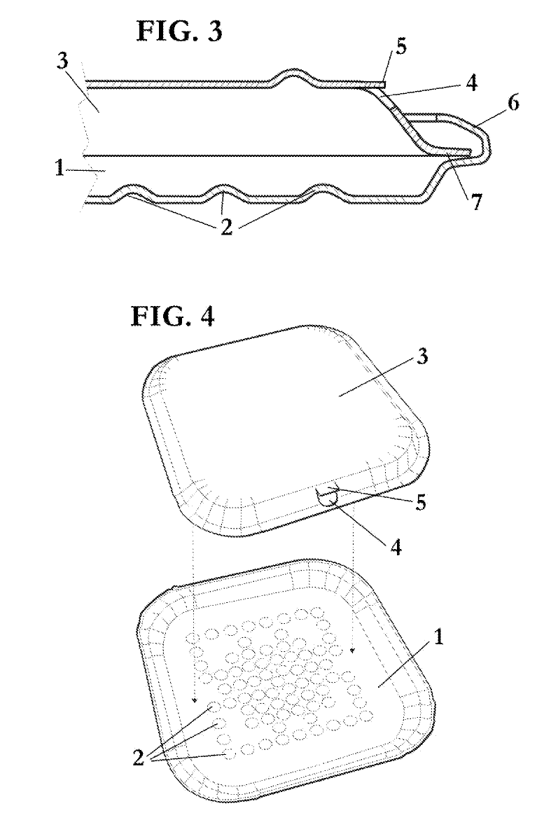

According to a first embodiment shown in FIGS. 1 and 2, the container is of circular plan shape, even though it could be of any suitable plan shape, as it is shown in FIG. 4, in which the container is of quadrangular plan shape.

Said protrusions 2 are distributed along said base 1 so that they are placed more near to each other at the center and they are more separated to each other when they are placed more near to the perimeter, i.e. the distance between the protrusions is lower in the center than to the perimeter. This arrangement is because the pizza is tenderer at the center than at its edges, so that it is necessary a greater support at the central part.

Furthermore, the lid 3 comprises at least one hole 4 provided with a tongue 5 to facilitated the removal of the lid 3, pulling said tongue 5.

The engagement between the lid 3 and the base 1 is not described in detail because it does not form part of the present invention. E.g., the engagement can be that disclosed in WO 2005/007525 cited above. This engagement is formed by a C-shape perimeter rim 6 provided at the base 1, inside which a perimeter protrusion 7 provided in the lid 3 is housed.

Even though reference is made to an specific embodiment of the invention, it is apparent for a person skilled in the art that the disclosed container is susceptible of numerous variations and modification, and that all the details can be substituted by other technically equivalent ones, without departing from the scope of protection defined by the attached claims.

1. Container for pizzas, comprising a base (1) housing a pizza, characterized in that said base (1) comprises a plurality of protrusions (2).

2. Container according to claim 1, characterized in that the separation between the protrusions (2) at the center of the base (1) is lower than the separation between the protrusions (2) near the perimeter of the base (1).

3. Container according to claim 1, characterized in that it also comprises a lid (3) engageable to said base (1), said lid (3) comprising at least one hole (4) provided with a tongue (5).
